(19) United States
(12) Patent Application Publication
(10) Pub. No.: US 2026/0010582 A1
(43) Pub. Date: Jan. 8, 2026

(54) HARDWARE ACCELERATOR FOR PERFORMING 1-DIMENSIONAL K-MEANS CLUSTERING IN PARALLEL

(71) Applicant: Microsoft Technology Licensing, LLC, Redmond, WA (US)

(72) Inventor: Robert Peter GMYR, Kirkland, WA (US)

(73) Assignee: Microsoft Technology Licensing, LLC, Redmond, WA (US)

(21) Appl. No.: 18/967,561

(22) Filed: Dec. 3, 2024

Related U.S. Application Data
(60) Provisional application No. 63/667,074, filed on Jul. 2, 2024.

(51) Int. Cl. G06F 17/16

(52) U.S. Cl. CPC G06F 17/16

(57) ABSTRACT

A hardware accelerator that performs k-means clustering on 1-dimensional inputs by computing a minimum within-cluster sum of squares matrix and a backtracking index, and using the backtracking index to identify start and end points for clusters within the 1-dimensional inputs. The within-cluster sum of squares matrix is generated in parallel by differing threads, using a two row ping pong buffer in shared memory of the thread block. The 1-dimensional inputs are read into shared memory and accessed as the threads compute successive rows of the minimum within-cluster sum of squares matrix. The backtrack index is stored in global memory and holds index values for the 1-dimensional inputs that minimize the minimum within-cluster sum of squares function at each element in the sum of squares matrix. After identifying the start and end points for the clusters, cluster labels can be generated for each of the 1-dimensional inputs.

### CROSS REFERENCE TO RELATED APPLICATIONS

This application claims priority to U.S. Provisional Patent Application Ser. No. 63/667,074, filed Jul. 2, 2024, the entirety of which is hereby incorporated herein by reference for all purposes.

### BACKGROUND

In the field of machine learning and other fields, k-means clustering is an unsupervised machine learning technique that can be used to sort data into groups. In k-means clustering, the objective is to partition a set of n data points into k clusters in which each data point belongs to the cluster with the nearest centroid. This problem is known to be computationally difficult (NP hard). Numerous variants of the k-means clustering problem exist, and various algorithms have been proposed to solve these k-means clustering problem variants. However, the performance of these algorithms on actual hardware can vary considerably. Particularly in the complex and computationally intensive field of machine learning for large language models, opportunities exist for improvement of hardware implementations of k-means clustering techniques, as discussed below.

### SUMMARY

In view of the above, according to one aspect a computing system is provided with a hardware accelerator configured to perform k-means clustering on 1-dimensional inputs sorted in non-descending order by implementing a dynamic programming algorithm that computes a minimum within-cluster sum of squares matrix for a predetermined number of clusters and computes a backtrack index of index values for the 1-dimensional inputs that produce the minimum values in the minimum within-cluster sum of squares matrix. The hardware accelerator backtracks through the backtrack index to compute cluster labels for each of the 1-dimensional inputs, and outputs the cluster labels.

According to another aspect, a computer system is provided with a hardware accelerator configured to perform k-means clustering on 1-dimensional inputs sorted in non-descending order by implementing a dynamic programming algorithm that computes a minimum within-cluster sum of squares matrix for a predetermined number of clusters and also computes a backtrack index of index values for the 1-dimensional inputs that produce the minimum values in the minimum within-cluster sum of squares matrix. In the hardware accelerator, the minimum within-cluster sum of squares matrix is generated in parallel by differing threads in a thread block, using a two row ping pong buffer that is instantiated in shared memory of the thread block to hold two rows of the minimum within-cluster sum of squares matrix at a time. The 1-dimensional inputs are read into shared memory and accessed by the threads of the thread block, as the threads compute successive rows of the minimum within-cluster sum of squares matrix. These values are computed based on data read from a source row of the ping pong buffer and on respective arrays of first constants and second constants and formulas computed by in program logic executed by the threads. The computed values for the minimum within-cluster sum of squares are stored in a target row of the ping pong buffer, and then the target and source rows of buffer are flipped for the next iteration, and so on until the minimum within-cluster sum of squares matrix is fully computed. The backtrack index is provisioned in global memory of the hardware accelerator, and index values for the 1-dimensional inputs that minimize the minimum within-cluster sum of squares function at each matrix element in the minimum within-cluster sum of squares matrix are written into the corresponding element for the backtrack index. The resulting backtrack index thus contains a series of non-descending index values. The backtrack index can be backtracked to determine the start and end index values within the 1-dimensional inputs for each cluster, and cluster labels can thus be generated for each of the 1-dimensional inputs and output from the hardware accelerator to memory, a program executing on processing circuitry, or storage, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a computing system with a hardware accelerator configured to implement k-means clustering as one step in reshaping tensor data prior to performing arithmetic operations on the tensor data at a tensor arithmetic unit of the hardware accelerator, according to one example implementation.

FIG. 2 is a schematic illustration of 1-dimensional inputs to the k-means clustering illustrated in FIG. 1, and an expression of clustering induced error.

FIG. 3 illustrates a minimum within-cluster sum of squares matrix D, computed by the k-means clustering module of the computing system of FIG. 1.

FIG. 4 illustrates the application of dynamic programming to solve the matrix D of FIG. 3.

FIG. 5 illustrates backtracking matrix B generated during the computation of matrix D, which stores the index values of 1-dimensional inputs that minimized D at each element of D.

FIG. 6 shows matrix D and a summary of the design elements of the hardware accelerator implementation illustrated in FIG. 7.

FIG. 7 is a schematic view of the hardware accelerator of FIG. 1 implementing the k-means clustering program in a parallel manner, using both global memory to store index B and shared memory to store a two row ping pong buffer in which a current portion of matrix D is stored.

FIG. 8 illustrates computations of the minimum within-cluster sum of squares matrix D and backtracking matrix B.

FIGS. 9 and 10 are a pseudo-code program listing of an example k-means clustering program to be executed in a CUDA environment.

FIG. 11 shows a flowchart of a computerized method for performing k-means clustering according to the present disclosure.

FIG. 12 shows a schematic view of an example computing environment in which the computing system of FIG. 1 may be enacted.

### DETAILED DESCRIPTION

The k-means clustering problem is a fundamental problem that originally arose in signal processing, and that now has a wide range of applications in machine learning. While the problem is NP-hard in general, recent research has shown that the 1-dimensional variant of the problem can be solved efficiently (in regard to computational complexity) and optimally (in regard to the quality of the result) via dynamic programming. Solving a single instance of the 1-dimensional k-means clustering problem in this manner on a single central processing unit (CPU) and even parallelizing the computation across the cores of a multi-core CPU to solve a few instances of the problem in parallel are relatively trivial tasks compared with solving thousands or even millions of small instances of the k-means clustering problem at scale in a complex machine learning application. Conventional hardware implementations of known k-means algorithms are prohibitively computationally expensive, slow, and costly to be implemented at such scale.

The systems and methods disclosed herein overcome the technical challenges associated with conventional hardware implementations of k-means clustering algorithms, by specially configuring a hardware accelerator to efficiently solve many instances of similarly structured, optimal 1-dimensional k-means clustering problem in parallel, achieving speed-ups over conventional implementations. Here, “similarly structured” refers to the fact that the number of points and the parameter k are identical in each of the problem instances, but the coordinates of the points vary. “Optimal” refers to the algorithm reaching the optimal clustering, rather than terminating after a specific number of rounds of clustering or after achieving a threshold error. “1-dimensional” refers to the input points being one dimensional inputs, as contrasted to 2-dimensional or higher dimensional inputs. Thus, the points are defined by one value, and are clustered linearly along a line. The points have index values, referred to as j herein. The manner in which the hardware accelerator is configured enables efficiencies great enough to employ the techniques described herein in machine learning operations that involve solving thousands, tens of thousands, or even millions of instances of the 1-dimensional the k-means clustering problem, for example, during training or inference using a large machine learning model.

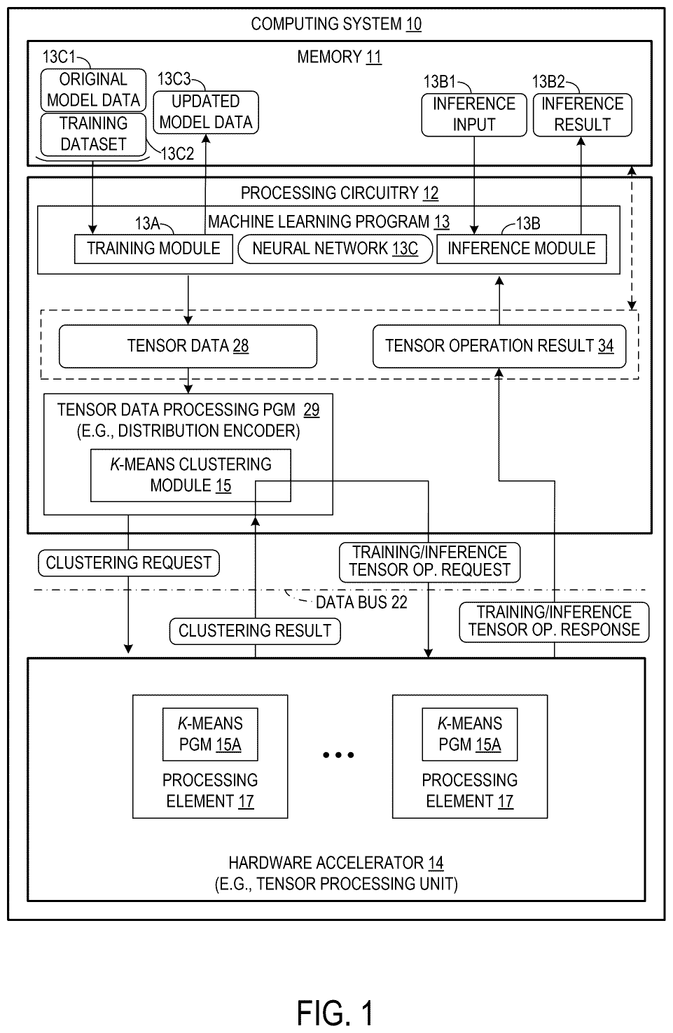

FIG. 1 shows a computing system 10 with processing circuitry 12 and a hardware accelerator 14 configured to handle tensor operations. The processing circuitry 12 is configured to implement a machine learning program 13, which may be or include a generative model such as a large language model (LLM) or large multimodal model (LMM). The generative model can be a LLM or LMM having billions of parameters, such as ORCA-2 or LLaMA-2, as some specific examples. The machine learning program 13 may, for example, include a generative model that uses a transformer architecture or a Mamba architecture. Other architectures such as recurrent neural network architectures and/or convolutional neural network architectures are also possible. The machine learning program 13 includes a neural network 13C having a plurality of deep learning layers connected by weights that are adjusted during training by a training module 13A, based on a training dataset 13C2, to transform an original model data 13C1 having original model weights into updated model data 13C3 having updated model weights. Machine learning program 13 also includes an inference module 13B that is configured to receive inference input 13B1 at inference time to the trained model, and produce an inference result 13B2. The processing circuitry 12 and hardware accelerator 14 can communicate over a data bus 22, and may be separate components or parts of a System on Chip (SoC), for example.

The hardware accelerator 14 can be configured during either training or inference to send tensor data 28 for processing to the hardware accelerator 14. For some tensor operations, such as encoding tensor data 28 using distribution encoding, it is useful to process the tensor data 28 prior to performing tensor operations. To this end, a tensor processing program 29 is provided. The tensor processing program 29 includes a k-means clustering module 15 configured to send clustering requests to the hardware accelerator 14 for a parallelized implementation of k-means clustering using the techniques described herein. On each of a plurality of processing elements 17 of the hardware accelerator 14, an instance of a k-means clustering program 15A provisioned by the k-means clustering module 15, is instantiated. A clustering request is sent to the hardware accelerator 14 from the k-means clustering module 15 with the tensor data 28 to be clustered, processed by the hardware accelerator 14, and a clustering result is returned. The processing circuitry 12 is configured to then perform an inference or training tensor operation based on the clustering result, by sending a training/inference tensor operation request to the hardware accelerator 14. In response, the hardware accelerator 14 performs the requested operation on the clustered data, and returns a tensor operation result 34 to the machine learning program 13.

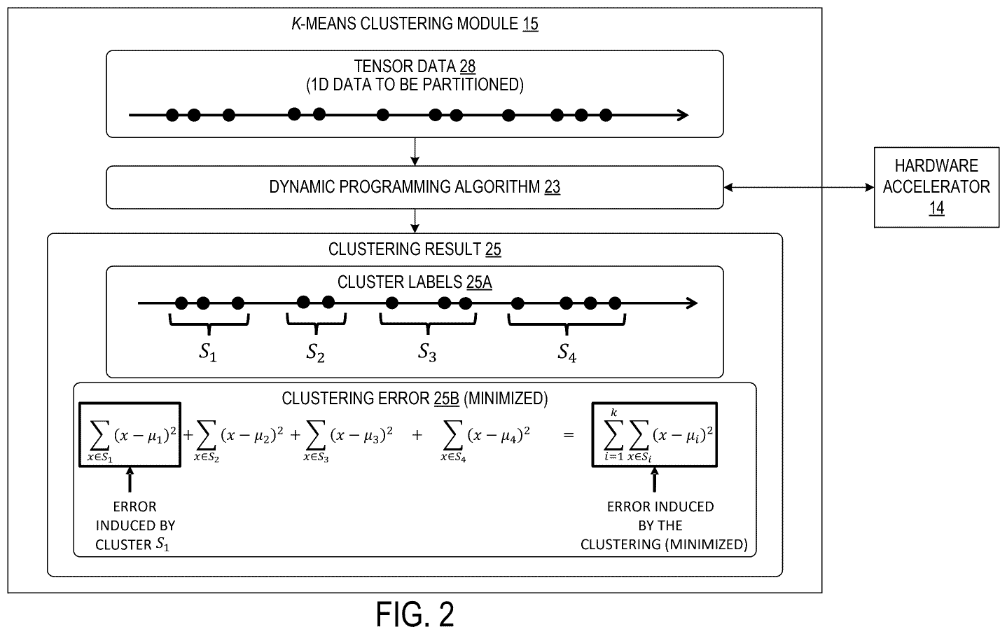

In the example of FIG. 1, the tensor data 28 includes 1-dimensional values, i.e., linear values that can be graphed as points on a line as shown in FIG. 2, such as weights of the neural network 13C. In order to perform the tensor operations for training or inference, it is technically desirable to cluster the 1-dimensional inputs of tensor data 28. To that end, the k-means clustering module 15 is configured to cluster the 1-dimensional inputs (elements of the tensor data 28) into clusters prior to sending the data to the hardware accelerator 14 with the training/inference tensor operation request. However, it will be appreciated that the data in neural network calculations can be thousands, tens of thousands, or millions of elements. Accordingly, the k-means clustering module 15 is carefully configured to deploy k-means program instances 15A on parallel processing elements 17 of the hardware accelerator 14 to maximize parallel computation, minimize read conflicts among memory banks in shared memory, minimize use of global memory, and where possible write contiguous portions of memory. These optimizations result in significant computational speed ups. Further, while this example uses training and inference of machine learning models as an illustrative example, it will be appreciated the k-means clustering module 15 and k-means programs 15A can be utilized to solve k-means clustering examples in other contexts as well.

Referring generally to FIGS. 2-6, the k-means algorithm implemented by the k-means program described herein is a dynamic programming algorithm that solves an instance of the k-means clustering problem. The instance can be one subset of a larger clustering problem, or one of many clustering problems in a batch. The dynamic programming algorithm 23 recursively subdivides an original k-means clustering task into a set of k-means clustering subtasks, and provides a logical formulation for combining solutions of the k-means clustering subtasks to form a solution with minimum clustering error. In practice, dynamic programming algorithms sequentially fill out a table containing solutions to increasingly complex subproblems. Once the entire table is filled, the solution for the original, given k-means clustering task can be deduced.

As shown in FIG. 2, the k-means clustering module 15 implements a dynamic programming algorithm 23 to cluster a set of 1-dimensional points x₁, . . . , xₙ received as tensor data 28 into k clusters with minimal error using the hardware accelerator 14. As a clustering result 25, clustering labels 25A are computed by the hardware accelerator 14 for the points, each clustering label 25A (e.g., S₁, S₂, S₃, S₄, etc.) identifying a cluster to which each point belongs. The points are shown as linear, i.e., arranged on a line. The clustering result 25 in some cases can also include a clustering error 25B, which is minimized by the dynamic programming algorithm 23. In other cases, the dynamic programming algorithm 23 outputs the cluster labels 25 and ensures that the clustering error 25B is minimized, but does not output the clustering error 25B. The clustering error 25B induced by clustering the points is the sum of the error induced by each cluster, which can be expressed as follows:

$${\sum }_{x ∈ {S}_{1}} {( x - {μ}_{1} )}^{2} + {\sum }_{x ∈ {S}_{2}} {( x - {μ}_{2} )}^{2} + {\sum }_{x ∈ {S}_{1}} {( x - {μ}_{1} )}^{2} ⋯ = {\sum }_{i = 1}^{k} {\sum }_{x ∈ {S}_{i}} {( x - {μ}_{i} )}^{2}$$

Formally, the k-means clustering task can be formulated as follows. For points x₁, . . . , xₙ∈ [symbol] and k∈ [symbol] find a partition of the points into sets Sᵢ for i∈[1, k] that minimizes

$${\sum }_{i = 1}^{k} {\sum }_{x ∈ {S}_{i}} {( x - {μ}_{i} )}^{2}$$

$$where {μ}_{i} = \frac{1}{\vert {S}_{i} \vert} {\sum }_{x ∈ {S}_{i}} x .$$

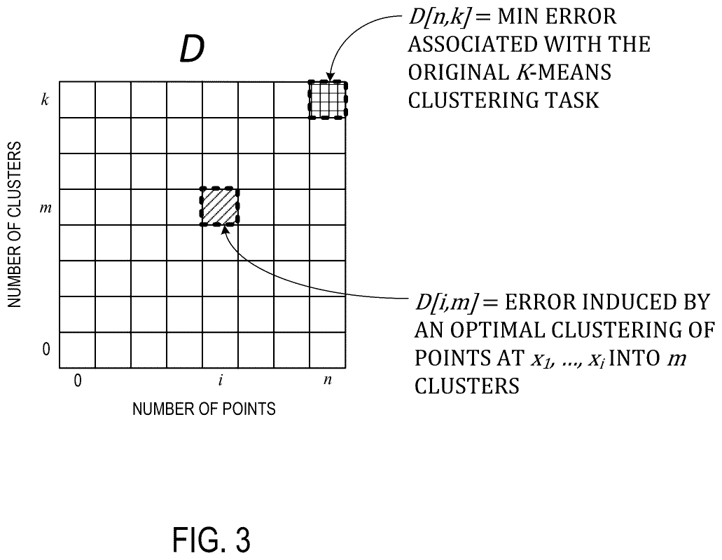

FIGS. 3-6 graphically illustrate the operation of the dynamic programming algorithm 23. With reference to FIG. 3, given n sorted numbers (or points in 1 dimension) and an integer k that specifies the desired number of clusters in the k-means clustering, the dynamic programming algorithm 23 iteratively computes the entries of a 2-dimensional table D of size k+1 by n+1. Table D is a matrix that serves as an index, and thus can also referred to as a matrix D or index D. The entry D[i, m] specifies the minimum error associated with clustering the first i points into m clusters. The final entry D[n, k] computed by the dynamic programming algorithm 23 specifies the minimum error associated with the original k-means clustering task.

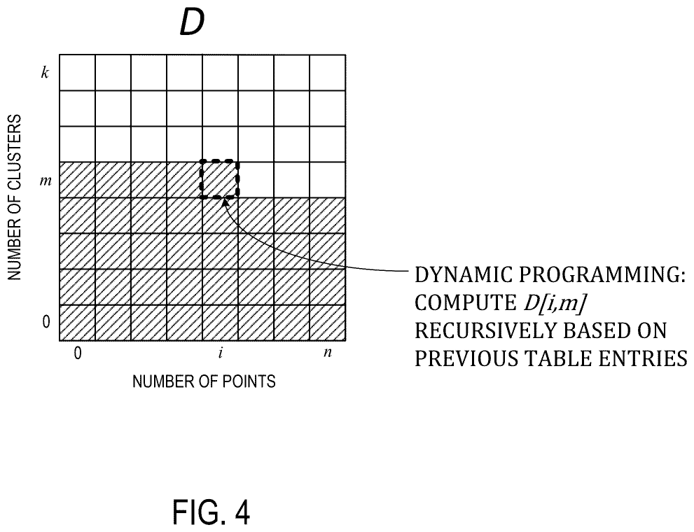

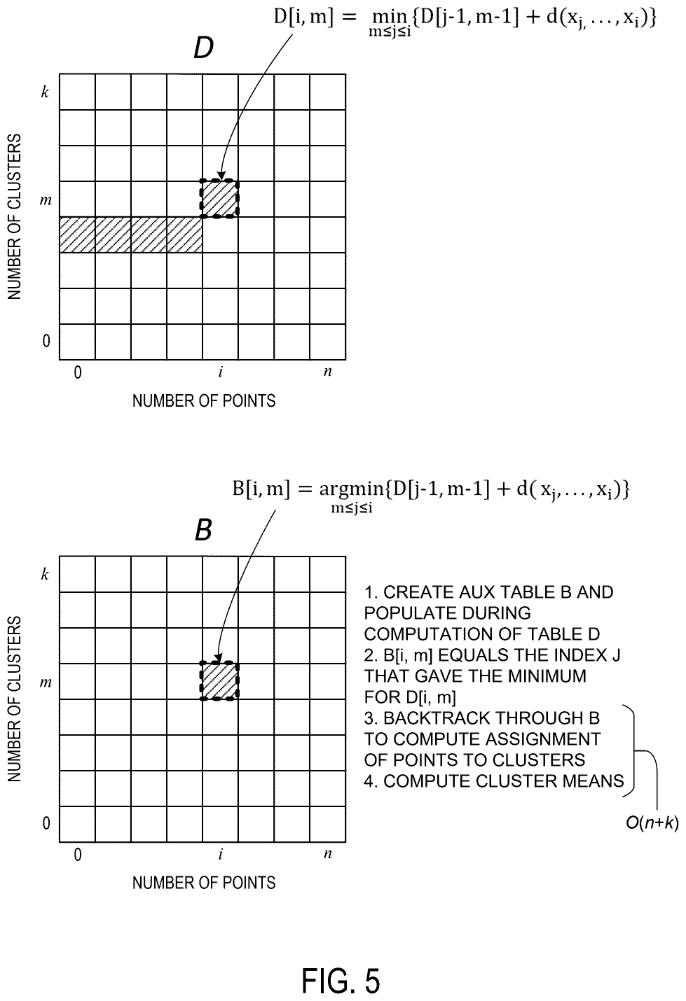

As shown in FIG. 4, dynamic programming algorithm 23 can be used to compute D[i, m] recursively based on previous entries in table D, shown in shading. To determine the actual structure of an optimal clustering (i.e., the assignment of points to clusters and the cluster centers) that minimizes clustering error 25B, the dynamic programming algorithm 23 uses backtracking. As shown in FIG. 5, during the computation of each element in table D, the dynamic programming algorithm 23 first creates and then fills out an auxiliary table B with the value of the index j for the 1-dimensional input that minimizes D[i,m]. D[i,m] can be computed as follows.

$$D [ i , m ] = {min}_{m \leq j \leq i} \{ D [ j - 1 , m - 1 ] + d ( {x}_{j} , … , {x}_{i} ) \}$$

Note that d(xⱼ , . . . , xᵢ) here is the sum of squared distances of xⱼ, . . . , xᵢ to their mean. Further, B[i,m] can be computed as follows.

$$B [ i , m ] = {arg min}_{m \leq j \leq i} \{ D [ j - 1 , m - 1 ] + d ( {x}_{j} , … , {x}_{i} ) \}$$

It will be appreciated that auxiliary table B is matrix that is used as an index, and thus can also be referred to as auxiliary matrix B and auxiliary index B. Once table B is computed, the dynamic programming algorithm then backtracks through the entries of B to determine the structure of an optimal clustering (i.e., to compute cluster labels for each point for the optimal clustering), and computes the cluster mean for each cluster. The optimal clustering is the clustering that minimizes the clustering error 25. These two steps occur in O(n+k) time, and thus are not computationally burdensome, as compared to the computation of table D and table B. A hardware accelerated implementation of this process will be described in greater detail below.

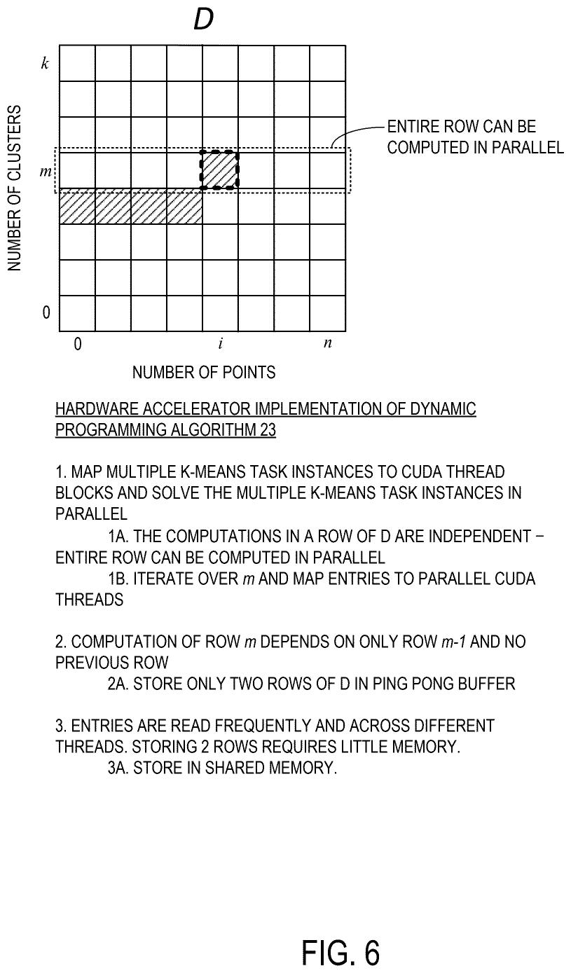

A naïve implementation of a conventional k-means clustering algorithm for solving a 1-dimensional k-means clustering problem on a CPU cannot achieve the processing efficiencies for use at scale on thousands, tens of thousands or millions of points. Accordingly hardware implementation details are described herein that efficiently utilize the compute and memory hierarchy of hardware accelerator 14 to achieve processing efficiencies when implementing the dynamic programming algorithm 23. The hardware accelerator 14 is able to run many execution threads in parallel. Threads are organized into thread groups (referred to as thread blocks) of a configurable size. Threads within a thread group can synchronize efficiently and collaborate by accessing shared memory. Hardware accelerator memory is subdivided into global memory GM and shared memory SM (See FIG. 6). Global memory GM is abundant but slow while shared memory SM is limited but fast. One particularity of shared memory SM is the phenomenon of memory bank access conflicts. Due to these memory bank access conflicts, the speed at which shared memory operates depends on the memory access pattern across warps, which are hardware-defined groups of a fixed number of (e.g., 32) threads that execute at the same time in single instruction multiple data (SIMD) fashion. If the access pattern does not follow specific rules, a bank conflict occurs which can slow down the memory access significantly.

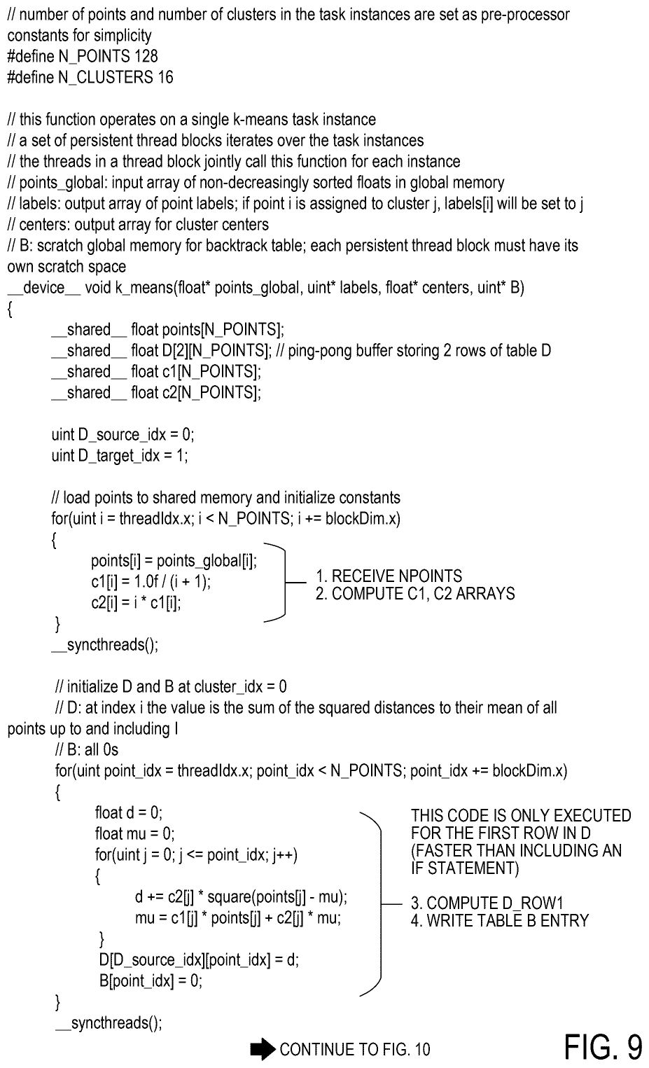

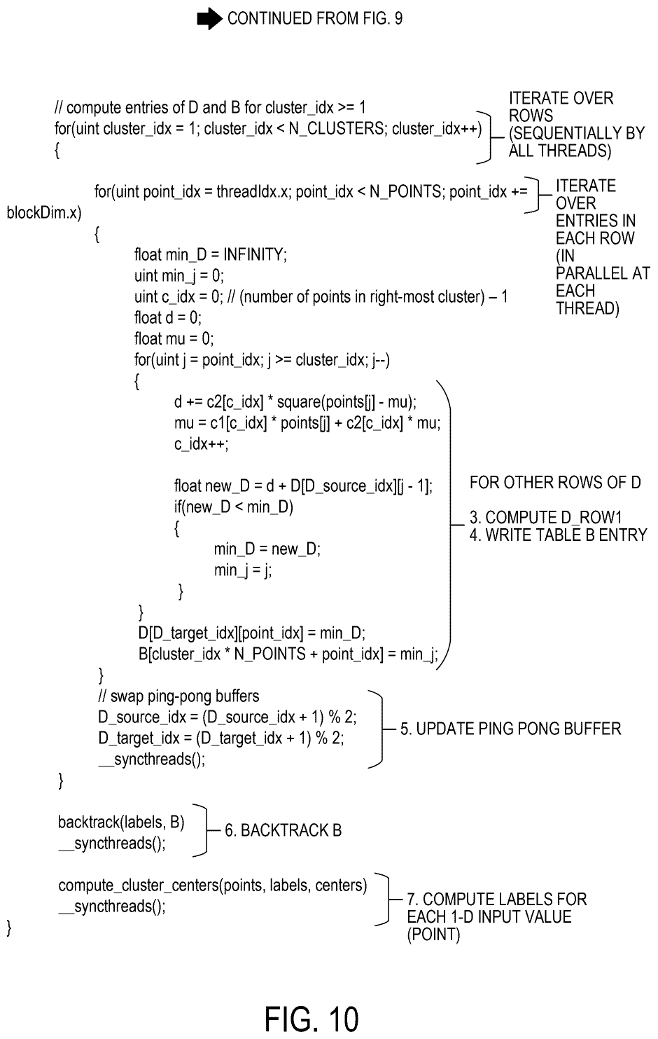

Various techniques are described below with reference to FIGS. 6-8 for efficiently parallelizing the dynamic programming algorithm 23 for k-means clustering on the hardware accelerator 14. Furthermore, pseudo-code is provided in FIGS. 9 and 10 for one example implementation of this algorithm.

The dynamic programming algorithm 23 is configured to solve many independent k-means clustering subtasks of the original k-means clustering task. As shown in FIG. 6 at (1), as a first layer of parallelization the k-means subtask instances from the original k-means clustering task are mapped to parallel thread blocks (e.g., CUDA thread blocks), enabling the multiple subtask instances to be solved in parallel. A fixed set of persistent thread blocks is used, and the instances are partitioned as evenly as possible among them. The number of thread blocks is a tunable parameter.

The recurrence equations for tables D and B imply certain data dependencies. Most notably, an entry D[m, i] depends only on entries D[m−1, j] in the row below but not on other entries in the same row (the same holds for B), as discussed at (1A) in FIG. 6. This allows a second layer of parallelization to be employed by mapping the entries of a row of table D (and table B) to separate threads as shown at (1B) in FIG. 6. Hence, entire rows of table D and table B can be computed in parallel instead of sequentially. The number of threads in a thread block is a tunable parameter.

As discussed at (2) in FIG. 6, the computation of an entry D[m, i] depends only on entries D[m−1, j] in the previous row of D but not on any other row. Furthermore, table D is not a prerequisite to compute the final output of the dynamic programming algorithm 23 since the clustering is deduced entirely from table B. Hence, the entire table D does not have to be stored. Instead, only 2 rows of D are stored as a “ping-pong buffer”, as discussed at (2A) in FIG. 6. The entries in a row are read frequently and by different threads in a thread block. Since only 2 rows need to be stored, those can be stored in shared memory for fast access. To do this, the dynamic programming algorithm 23 iterates over m and maps entries to parallel threads.

The backtrack table B is stored in its entirety since it is unknown ahead of time which entries will be used during backtracking. Each entry of backtrack table B is written exactly once and read at most once in one efficient implementation of the backtracking. Hence, backtrack table B can be stored in high bandwidth memory (HBM), i.e., global memory. The threads in a warp write entries of backtrack table B to consecutive memory locations which may allow for coalesced writes on some GPU architectures.

The dynamic programming algorithm 23 is configured such that the input points are read frequently and by different threads in a thread block. The input points are copied to shared memory for efficient access. The dynamic programming algorithm is further configured to avoid shared memory bank conflicts.

The recursive computation by the dynamic programming algorithm 23 of the quantities mu_i and d(xⱼ, . . . , xᵢ) relies on a set of implicit constants. These constants (arrays c1 and c2 below) are explicitly precomputed and reused for efficiency.

The pseudo-code in FIGS. 9 and 10 follows a style similar to Nvidia's CUDA C++. The details of backtracking and the cluster center computation are omitted since those parts are straightforward and computationally inexpensive compared to the core loop.

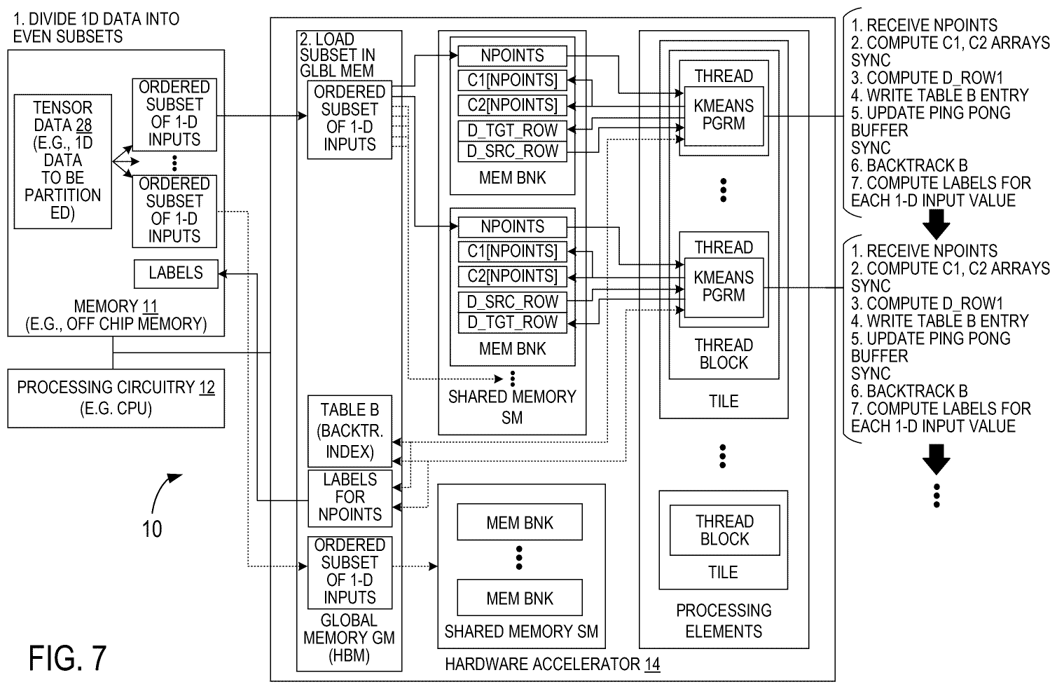

Referring to FIG. 7, a computing system 10 is provided that includes processing circuitry 12 and associated memory 11 storing a plurality of 1-dimensional inputs as tensor data 28 to be clustered. The computing system 10 further includes the hardware accelerator 14 configured to perform k-means clustering on the 1-dimensional inputs sorted in non-descending order by implementing a dynamic programming algorithm that computes a minimum within-cluster sum of squares matrix D for a predetermined number of clusters and computes a backtrack index B of index values for the 1-dimensional inputs that produce the minimum values in the minimum within-cluster sum of squares matrix D. The 1-dimensional inputs are typically broken down into a plurality of subsets. Each of the subsets of 1-dimensional inputs is then ordered in a preprocessing step such that its elements are non-descending. The hardware accelerator 14 is configured to: load the plurality of 1-dimensional inputs 28 in each subset into global memory GM of the hardware accelerator 14, and perform parallel execution of a k-means clustering program on each subset via each of a plurality of threads of a plurality of thread blocks executing on a plurality of processing elements of the hardware accelerator 14. The k-means clustering is accomplished at least in part by, at each thread block: looping through each thread on a first loop to: copy a respective predetermined number (N) of the 1-dimensional inputs 28 in a subset (ordered in non-descending order) from global memory GM into a respective memory bank BNK of shared memory SM, such that each thread accesses a different one of the memory banks BNK to retrieve its respective 1-dimensional inputs in tensor data 28 (that is, the 1-dimensional inputs are read into shared memory SM and accessed by a plurality of threads in a thread block of the hardware accelerator 14); and precompute a first constant (C1) and a second constant (C2) for each of the predetermined number of the 1-dimensional inputs 28 and store precomputed values for the first constant (C1) and second constant (C2) in the respective memory bank for each thread in shared memory SM. Next, the hardware accelerator performs a first syncing of the threads.

Then, the minimum within-cluster sum of squares matrix is generated in parallel by the plurality of threads, using a two row ping pong buffer instantiated in shared memory to hold two rows of the minimum within-cluster sum of squares matrix at a time. Specifically, the hardware accelerator 14 loops through each thread in a second loop to: at each thread, loop through each element in a successive row of a minimum within-cluster sum of squares matrix, to: read one or more values in a source row of a ping pong buffer PPB as inputs, compute a sum of squares based on the one or more source row values, the first constant and the second constant, evaluate the computed sum of squares for a minimum within-cluster sum of squares value, write the computed minimum within-cluster sum of squares value to a target row of the ping-pong buffer in shared memory as output, and write an index value for the 1-dimensional input with the minimum within-cluster sum of squares value to a backtrack index B that is stored in global memory GM. Following this, the hardware accelerator 14 is configured to backtrack through the backtrack index B to identify the start of and end index value each cluster, label all 1-dimensional inputs with cluster labels, compute cluster labels for each of the 1-dimensional inputs, and output the cluster labels for the 1-dimensional inputs.

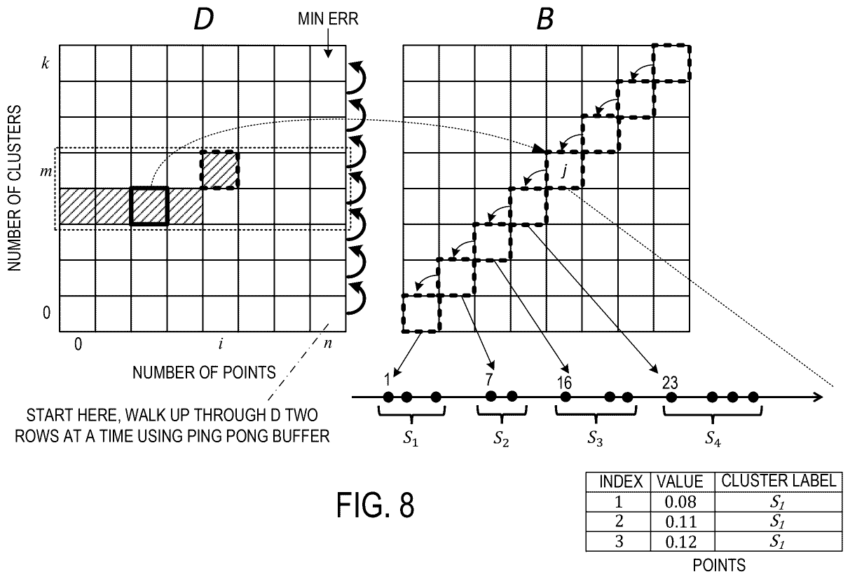

FIG. 8 illustrates the computation of table D, two rows at a time, and then writing the index of the 1-dimensional input that minimizes D[i, m] in the corresponding element of backtracking index B. FIG. 8 also illustrates backtracking through the backtracking index B to identify the start and end 1-dimensional input index value of each cluster. In the illustrated example, clusters S₁-S₄ are determined to start at indexes 1, 7, 17 and 23. Other clusters are present further along the number line but not illustrated for sake of simplicity. Labels for each point can then be computed, as shown in the example table of point indexes, values, and cluster labels, which includes just three entries for S₁ but in actuality would include entries for all points in the 1-dimensional inputs. The backtracking appears in a linear diagonal pattern in FIG. 8 due to the small size of the example matrix B, however in practical application the backtracking will start at the top right element, and move one row down and leftward until all rows have been traversed, not necessarily in a linear fashion when the table has more columns than rows. Only one element can be identified for backtracking in each row, and the movement is always downward and to the left when backtracking.

FIGS. 9 and 10 illustrate example pseudo code for the k-means program that implements the dynamic programming algorithm 23 in hardware as described herein. The code includes descriptive comments within the pseudo code itself and also annotations labelling the code with functional statements. As the pseudo code is definite and would be understood by those skilled in the art, it will not be described in detail for sake of brevity.

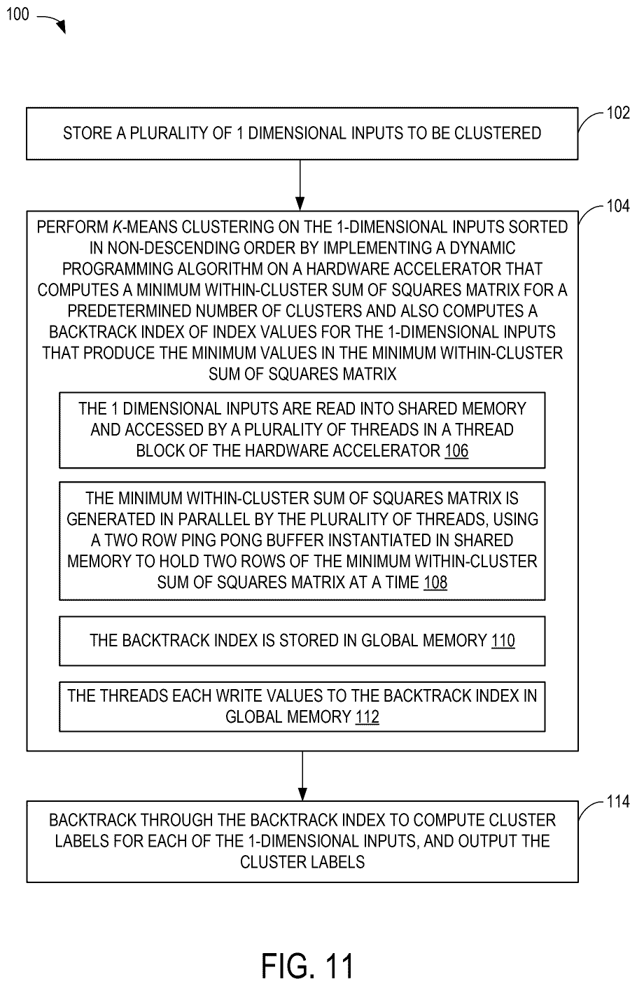

FIG. 11 shows a flowchart of a computerized method 100 for performing k-means clustering according to the present disclosure. The method 100 may be implemented by the computing system 10 illustrated in FIGS. 1, 2, and 7, or other suitable computing hardware and software.

At 102, the method 100 may include storing a plurality of 1-dimensional inputs to be clustered. At 104, the method 100 may include performing k-means clustering on the 1-dimensional inputs sorted in non-descending order by implementing a dynamic programming algorithm on a hardware accelerator that computes a minimum within-cluster sum of squares matrix for a predetermined number of clusters and also computes a backtrack index of index values for the 1-dimensional inputs that produce the minimum values in the minimum within-cluster sum of squares matrix. As shown at 106, the 1-dimensional inputs are read into shared memory and accessed by a plurality of threads in a thread block of the hardware accelerator. As shown at 108, the minimum within-cluster sum of squares matrix is generated in parallel by the plurality of threads, using a two row ping pong buffer instantiated in shared memory to hold two rows of the minimum within-cluster sum of squares matrix at a time. As shown at 110, the backtrack index is stored in global memory. As shown at 112, the threads each write values to the backtrack index in global memory. At 114, the method 100 may further include backtracking through the backtrack index to compute cluster labels for each of the 1-dimensional inputs, and outputting the cluster labels. It will be appreciated that the 1-dimensional inputs may be associated with a training task or inference task of a machine learning model, and the output may be used to perform calculations for adjusting the weights of the machine learning model after completion of the training task, or to perform calculations to compute an inference result of the inference task. Thus, the 1-dimensional inputs may be weight values, activation values, etc. of the machine learning model, for example.

The above described systems and methods can be implemented to efficiently perform k-means clustering of 1-dimensional inputs in hardware with parallelization of computations, avoidance of memory bank conflicts, and increased use of coalesced writes, to thereby achieve processing efficiency sufficient to support such clustering in large scale inference and training of machine learning models.

In some embodiments, the methods and processes described herein may be tied to a computing system of one or more computing devices. In particular, such methods and processes may be implemented as a computer-application program or service, an application-programming interface (API), a library, and/or other computer-program product.

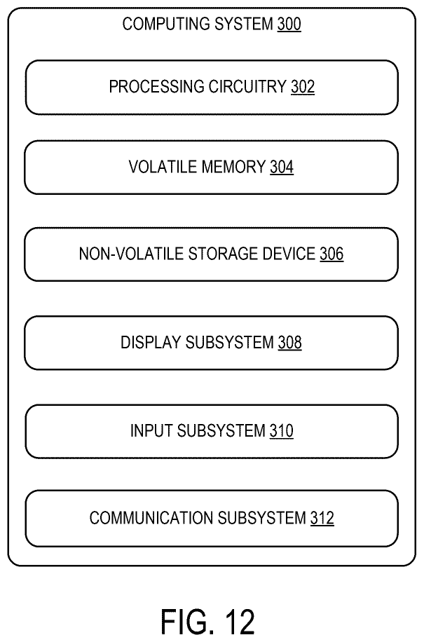

FIG. 12 schematically shows a non-limiting embodiment of a computing system 300 that can enact one or more of the methods and processes described above. Computing system 300 is shown in simplified form. Computing system 300 may embody the computing system 10 described above and illustrated in FIGS. 1 and 7. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 12.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions.

Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local-or wide-area network, broadband cellular network, etc. In some embodiments, the communication subsystem may allow computing system 300 to send and/or receive messages to and/or from other devices via a network such as the Internet.

The following paragraphs provide additional description of aspects of the present disclosure. According to a first aspect, a comp computing system is provided, including: processing circuitry and associated memory storing a plurality of 1-dimensional inputs to be clustered; and a hardware accelerator configured to perform k-means clustering on the 1-dimensional inputs sorted in non-descending order by implementing a dynamic programming algorithm that computes a minimum within-cluster sum of squares matrix for a predetermined number of clusters and computes a backtrack index of index values for the 1-dimensional inputs that produce the minimum values in the minimum within-cluster sum of squares matrix. The hardware accelerator backtracks through the backtrack index to compute cluster labels for each of the 1-dimensional inputs, and outputs the cluster labels.

In this aspect, the 1-dimensional inputs can be read into shared memory and accessed by a plurality of threads in a thread block of the hardware accelerator.

Further in this aspect, the minimum within-cluster sum of squares matrix can be generated in parallel by the plurality of threads, using a two row ping pong buffer instantiated in shared memory to hold two rows of the minimum within-cluster sum of squares matrix at a time.

Further in this aspect, the backtrack index can be stored in global memory.

Further in this aspect, the threads can each write values to the backtrack index in global memory.

Further in this aspect, the hardware accelerator can be further configured to: load the plurality of 1-dimensional inputs into global memory of the hardware accelerator; and perform parallel execution of a k-means clustering program via each of a plurality of threads of a plurality of thread blocks executing on a plurality of processing elements of the hardware accelerator.

Further in this aspect, the processing circuitry can be configured to implement a machine learning program that is a generative model.

Further in this aspect, the processing circuitry and the hardware accelerator can communicate over a data bus and are separate components or parts of a System on Chip (SoC).

Further in this aspect, the dynamic programming algorithm recursively can subdivide an original k-means clustering task into a set of k-means clustering subtasks, and can provide a logical formulation for combining solutions of the k-means clustering subtasks to form a solution with minimum clustering error. Further in this aspect, movement is downward and to left when backtracking through the backtrack index.

According to another aspect, a computerized method is provided, including: storing a plurality of 1-dimensional inputs to be clustered; performing k-means clustering on the 1-dimensional inputs sorted in non-descending order by implementing a dynamic programming algorithm on a hardware accelerator that computes a minimum within-cluster sum of squares matrix for a predetermined number of clusters and also computes a backtrack index of index values for the 1-dimensional inputs that produce the minimum values in the minimum within-cluster sum of squares matrix; and backtracking through the backtrack index to compute cluster labels for each of the 1-dimensional inputs, and outputting the cluster labels.

In this aspect, the 1-dimensional inputs can be read into shared memory and accessed by a plurality of threads in a thread block of the hardware accelerator.

Further in this aspect, the minimum within-cluster sum of squares matrix can be generated in parallel by the plurality of threads, using a two row ping pong buffer instantiated in shared memory to hold two rows of the minimum within-cluster sum of squares matrix at a time.

Further in this aspect, the backtrack index can be stored in global memory.

Further in this aspect, the threads can each write values to the backtrack index in global memory.

Further in this aspect, the method can further include loading the plurality of 1-dimensional inputs into global memory of the hardware accelerator; and performing parallel execution of a k-means clustering program via each of a plurality of threads of a plurality of thread blocks executing on a plurality of processing elements of the hardware accelerator.

Further in this aspect, the method can further include implementing a machine learning program that is a generative model.

Further in this aspect, the hardware accelerator can be one of components of a System on Chip (SoC).

Further in this aspect, movement is downward and to left when backtracking through the backtrack index.

According to another aspect, a computing system is provided, including: processing circuitry and associated memory storing a plurality of 1-dimensional inputs to be clustered; and a hardware accelerator configured to load the plurality of 1-dimensional inputs into global memory of the hardware accelerator, perform parallel execution of a k-means clustering program via each of a plurality of threads of a plurality of thread blocks executing on a plurality of processing elements of the hardware accelerator. This can be accomplished, at least in part by, at each thread block: looping through each thread on a first loop to: copy a respective predetermined number (N) of the 1-dimensional inputs from global memory into a respective memory bank of shared memory, such that each thread accesses a different one of the memory banks to retrieve its respective 1-dimensional inputs; and precompute a first constant (C1) and a second constant (C2) for each of the predetermined number of the 1-dimensional inputs and store precomputed values for the first constant (C1) and second constant (C2) in the respective memory bank for each thread in shared memory; and perform first syncing of the threads. Then, loop through each thread in a second loop to: at each thread, loop through each element in a successive row of a minimum within-cluster sum of squares matrix, to: read one or more values in a source row of a ping pong buffer as inputs, compute a sum of squares based on the one or more source row values, the first constant and the second constant, evaluate the computed sum of squares for a minimum within-cluster sum of squares value, and write the computed minimum within-cluster sum of squares value to a target row of the ping-pong buffer in shared memory as output; write an index value for the 1-dimensional input with the minimum within-cluster sum of squares value to a backtrack index stored in global memory; backtrack through the backtrack index to identify the start of and end index value each cluster; label all 1-dimensional inputs with cluster labels; and output the cluster labels for the 1-dimensional inputs.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and associated memory storing a plurality of 1-dimensional inputs to be clustered; and
a hardware accelerator configured to perform k-means clustering on the 1-dimensional inputs sorted in non-descending order by implementing a dynamic programming algorithm that computes a minimum within-cluster sum of squares matrix for a predetermined number of clusters and computes a backtrack index of index values for the 1-dimensional inputs that produce the minimum values in the minimum within-cluster sum of squares matrix, wherein
the hardware accelerator backtracks through the backtrack index to compute cluster labels for each of the 1-dimensional inputs, and outputs the cluster labels.

2. The computing system of claim 1, wherein
the 1-dimensional inputs are read into shared memory and accessed by a plurality of threads in a thread block of the hardware accelerator.

3. The computing system of claim 1, wherein
the minimum within-cluster sum of squares matrix is generated in parallel by the plurality of threads, using a two row ping pong buffer instantiated in shared memory to hold two rows of the minimum within-cluster sum of squares matrix at a time.

4. The computing system of claim 1, wherein
the backtrack index is stored in global memory.

5. The computing system of claim 1, wherein
the threads each write values to the backtrack index in global memory.

6. The computing system of claim 1, wherein
the hardware accelerator is further configured to:
load the plurality of 1-dimensional inputs into global memory of the hardware accelerator; and
perform parallel execution of a k-means clustering program via each of a plurality of threads of a plurality of thread blocks executing on a plurality of processing elements of the hardware accelerator.

7. The computing system of claim 1, wherein
the processing circuitry is configured to implement a machine learning program that is a generative model.

8. The computing system of claim 1, wherein
the processing circuitry and the hardware accelerator communicate over a data bus and are separate components or parts of a System on Chip (SoC).

9. The computing system of claim 1, wherein
the dynamic programming algorithm recursively subdivides an original k-means clustering task into a set of k-means clustering subtasks, and provides a logical formulation for combining solutions of the k-means clustering subtasks to form a solution with minimum clustering error.

10. The computing system of claim 1, wherein
movement is downward and to left when backtracking through the backtrack index.

11. A computerized method, comprising:
storing a plurality of 1-dimensional inputs to be clustered;
performing k-means clustering on the 1-dimensional inputs sorted in non-descending order by implementing a dynamic programming algorithm on a hardware accelerator that computes a minimum within-cluster sum of squares matrix for a predetermined number of clusters and also computes a backtrack index of index values for the 1-dimensional inputs that produce the minimum values in the minimum within-cluster sum of squares matrix; and
backtracking through the backtrack index to compute cluster labels for each of the 1-dimensional inputs, and outputting the cluster labels.

12. The computerized method of claim 11, wherein
the 1-dimensional inputs are read into shared memory and accessed by a plurality of threads in a thread block of the hardware accelerator.

13. The computerized method of claim 11, wherein
the minimum within-cluster sum of squares matrix is generated in parallel by the plurality of threads, using a two row ping pong buffer instantiated in shared memory to hold two rows of the minimum within-cluster sum of squares matrix at a time.

14. The computerized method of claim 11, wherein
the backtrack index is stored in global memory.

15. The computerized method of claim 11, wherein
the threads each write values to the backtrack index in global memory.

16. The computerized method of claim 11, further comprising:
loading the plurality of 1-dimensional inputs into global memory of the hardware accelerator; and
performing parallel execution of a k-means clustering program via each of a plurality of threads of a plurality of thread blocks executing on a plurality of processing elements of the hardware accelerator.

17. The computerized method of claim 11, further comprising:
implementing a machine learning program that is a generative model.

18. The computerized method of claim 11, wherein
the hardware accelerator is one of components of a System on Chip (SoC).

19. The computerized method of claim 11, wherein
movement is downward and to left when backtracking through the backtrack index.

20. A computing system, comprising:
processing circuitry and associated memory storing a plurality of 1-dimensional inputs to be clustered; and
a hardware accelerator configured to:
load the plurality of 1-dimensional inputs into global memory of the hardware accelerator;
perform parallel execution of a k-means clustering program via each of a plurality of threads of a plurality of thread blocks executing on a plurality of processing elements of the hardware accelerator, at least in part by:
at each thread block:
looping through each thread on a first loop to:
copy a respective predetermined number (N) of the 1-dimensional inputs from global memory into a respective memory bank of shared memory, such that each thread accesses a different one of the memory banks to retrieve its respective 1-dimensional inputs; and
precompute a first constant (C1) and a second constant (C2) for each of the predetermined number of the 1-dimensional inputs and store precomputed values for the first constant (C1) and second constant (C2) in the respective memory bank for each thread in shared memory; and
perform first syncing of the threads;
loop through each thread in a second loop to:
at each thread, loop through each element in a successive row of a minimum within-cluster sum of squares matrix, to:
read one or more values in a source row of a ping pong buffer as inputs,
compute a sum of squares based on the one or more source row values, the first constant and the second constant,
evaluate the computed sum of squares for a minimum within-cluster sum of squares value, and
write the computed minimum within-cluster sum of squares value to a target row of the ping-pong buffer in shared memory as output;
write an index value for the 1-dimensional input with the minimum within-cluster sum of squares value to a backtrack index stored in global memory;
backtrack through the backtrack index to identify the start of and end index value each cluster;
label all 1-dimensional inputs with cluster labels; and
output the cluster labels for the 1-dimensional inputs.
